(19) United States
(12) Patent Application Publication
(10) Pub. No.: US 2008/0268157 A1
(43) Pub. Date: Oct. 30, 2008

(54) METHOD FOR IMPARTING STRETCH AND RECOVERY TO FABRICS

(76) Inventor: Herman S. Roup, Santa Barbara, CA (US)

Correspondence Address: GREENBERG TRAURIG LLP (LA), 2450 COLORADO AVENUE, SUITE 400E, INTELLECTUAL PROPERTY DEPARTMENT, SANTA MONICA, CA, 90404, US

(21) Appl. No.: 12/111,942

(22) Filed: Apr. 29, 2008

Related U.S. Application Data
(60) Provisional application No. 60/914,959, filed on Apr. 30, 2007.

(51) Int. Cl. B05D 3/02

(52) U.S. Cl. 427/372.2

(57) ABSTRACT

A desired stretch and recovery characteristic is imparted to woven fabric that contain yard strands. A fabric has yarn strands that are in a compacted state and affixing at least one adhesive liquid with known stretch and recovery characteristics to the fabric with the yarn strands in a compacted state. The affixed adhesive liquid thereby maintains the desired stretch and recovery characteristic of the fabric. An elongated stabilizer is applied to the fabric to stabilize the yarn strands in their compacted state before the adhesive liquid is being applied. The fabric is guided through a trough and the adhesive liquid is dispensed and then spread on the fabric. The fabric with the affixed adhesive liquid is cured in an oven.

### RELATED APPLICATION

This application claims the benefit of and priority to U.S. Provisional Application Ser. No. 60/914,959, filed Apr. 30, 2007, the contents of which are incorporated by reference herein in its entirety.

### BACKGROUND

The present disclosure relates to a process for treating fabric and to a fabric construction system. In particular, though not exclusively, this process is for application in clothing manufacture. This enables a certain degree and type of stretch and recovery to be imparted into, for example, a waistband or other portions of a garment.

Conventionally, an elasticized waistband interlining with the outer fabric of the waistband ruched or gathered, are used to provide a large degree of stretch. However, a ruched waistband compromises the tailored look and fit of a garment.

Alternatively, a non-stretch interlining may be used as a stiffener for the outer fabric, affording some degree of reinforcement and added resilience. However, a non-stretch interlining provides little give or ease in the area of the garment that incorporates the waistband. For example, when the waist expands after meals, the fit of the garment may become uncomfortable to the wearer. In addition, a wearer falling mid-way between sizing of off-the-shelf waistbanded garments may be forced to select a garment which is either too tight or too loose during normal wear.

The present disclosure minimizes disadvantages of existing systems that are known to impart stretch and recovery.

### SUMMARY

In accordance with one aspect of the present disclosure, a method is provided for imparting a desired stretch and recovery characteristic to woven fabric that contain yard strands. The method comprises providing a fabric having yarn strands that are in a compacted state and affixing at least one adhesive liquid with known stretch and recovery characteristics to the fabric with the yarn strands in a compacted state. The affixed adhesive liquid thereby maintains the desired stretch and recovery characteristic of the fabric.

In one embodiment, the adhesive liquid establishes a stretch and recovery characteristic once the adhesive liquid is baked.

The method comprises applying heat and pressure to the fabric in such a manner that the yarn strands are forced into a compacted state. A stretchable and recoverable adhesive ink or plastisol is then affixed to the fabric with the yarn strands in a compacted state. The affixed stretchable and recoverable adhesive ink or plastisol thereby maintains the desired stretch and recovery characteristic of the fabric.

The method for imparting a desired stretch and recovery characteristic to woven fabric which contain yard strands also includes affixing at least one elongated stabilizer to the fabric with the yarn strands in a compacted state. The at least one affixed elongated stabilizer stabilizes the yard strands in the compacted state prior to affixing the at least one adhesive liquid with known stretch and recovery characteristics to the fabric.

The elongated stabilizer can be dissolvable. The elongated stabilizer can be a cord, thread, or tape.

The method for imparting a desired stretch and recovery characteristic to woven fabric which contain yard strands further includes guiding the fabric through a trough having an inner bottom surface.

The trough can have a groove on the inner bottom surface. The groove is sized such that a stitched cord may protrude into the groove thereby allowing the fabric to lay flat on the inner bottom surface.

The desired stretch and recovery characteristic further includes dispensing the adhesive liquid with a dispenser from a dispense tank that is under pressure.

Imparting a desired stretch and recovery characteristic to woven fabric which contain yard strands further includes spreading the adhesive liquid with a spreader.

Imparting a desired stretch and recovery characteristic to woven fabric which contain yard strands further includes restricting the area of affixing the adhesive liquid with a print guide.

Imparting a desired stretch and recovery characteristic to woven fabric which contain yard strands further includes collecting excess adhesive liquid from the fabric with a side wall of the print guide or a dam wall.

The collection of excess adhesive liquid includes withdrawing the excess adhesive liquid collected by the side wall of the print guide or a dam wall with at least one tube.

The desired stretch and recovery characteristic further includes curing the adhesive liquid affixed to the fabric in an oven.

### DRAWINGS

The above-mentioned features and objects of the present disclosure will become more apparent with reference to the following description taken in conjunction with the accompanying drawings wherein like reference numerals denote like elements and in which:

FIG. 1 illustrates the preparation of stretchable fabric;

FIG. 2 is a schematic drawing of the machine process for compacting fabric;

FIG. 3 illustrates fabric strands drawing closer together;

FIG. 4 is a perspective view of an apparatus for affixing an adhesive liquid with a known stretch and recovery characteristic;

FIG. 5 is a top-down view of the compacted fabric moving through the trough;

FIG. 6 is a cross-sectional view of the compacted fabric stitched with a cord moving through the trough;

FIG. 7 is a cross-sectional view of the compacted fabric affixed with a dissolvable tape on the bottom moving through a trough;

FIG. 8 is a front view of the dispenser attached to the trough;

FIG. 9 is a front view of the spreader attached to the trough;

FIG. 10 is a back view of the dam wall attached to the trough; and

FIG. 11 illustrates a compacted fabric with a elongated stabilizer attached as well as an adhesive liquid affixed.

FIG. 12 is a perspective view of an apparatus for affixing an adhesive liquid with a known stretch and recovery characteristic.

FIG. 13 is a top-down view of the compacted fabric moving through the trough with side blocks.

### DETAILED DESCRIPTION

The disclosure is concerned primarily with consistently achieving ease and comfort using conventional non-stretch fabrics, for example those where the inherent characteristic in the length or width of the material does not have a sufficient degree of ease or stretch to enable a stretch waistband to be produced with conventional methods. Some examples of such fabrics include woven or knitted combinations of polyester/wool, polyester/viscose, cotton etc. It is intended that the fabric so treated would be an outer fabric, but the process can also be applied to lining or interlining fabrics, inner self fabric, or one-piece waistbands.

There is a method for imparting a desired stretch and recovery characteristic to woven fabric that contain yard strands. A fabric has yarn strands that are in a compacted state and affixing at least one adhesive liquid with known stretch and recovery characteristics to the fabric with the yarn strands in a compacted state. The affixed adhesive liquid thereby maintains the desired stretch and recovery characteristic of the fabric. In one embodiment, the adhesive liquid establishes a stretch and recovery characteristic once the adhesive liquid is baked.

In another aspect there a method for imparting a desired stretch and recovery characteristic to woven fabric that contain yard strands. Heat and pressure is applied to the fabric in such a manner that the yarn strands are forced into a compacted state. A stretchable and recoverable adhesive ink or plastisol is then affixed to the fabric with the yarn strands in a compacted state. The affixed stretchable and recoverable adhesive ink or plastisol thereby maintains the desired stretch and recovery characteristic of the fabric.

A desired stretch and recovery characteristic is imparted to woven fabric which contain yard strands also includes affixing at least one elongated stabilizer to the fabric with the yarn strands in a compacted state. The affixed at least one elongated stabilizer stabilizes the yard strands in the compacted state prior to affixing the at least one adhesive liquid with known stretch and recovery characteristics to the fabric. As an example, the elongated stabilizer may be a cord, thread, or tape. In some cases, the elongated stabilizer is dissolvable by heat or water.

The method for imparting a desired stretch and recovery characteristic to woven fabric which contain yard strands further includes guiding the fabric through a trough having an inner bottom surface. The trough has a groove on the inner bottom surface. The groove is sized such that a stitched cord may protrude into the groove thereby allowing the fabric to lay flat on the inner bottom surface. In some cases, the inner bottom surface of the trough is at least one conveyor belt.

Also the adhesive is dispensed as a adhesive liquid with a dispenser. The dispenser may be attached to the trough and may also be attached to a feeding tank. The dispenser can have a broadened opening.

In another form, the dispenser is a spray. Further, at least one of an angle and a position of the dispenser relative to the fabric may be adjusted.

In another aspect, the method for imparting a desired stretch and recovery characteristic to woven fabric which contain yard strands further includes spreading the adhesive liquid with a spreader. The spreader may be attached to the trough. In one embodiment, at least one of an angle and a position of the spreader relative to the fabric may be adjusted.

Imparting a desired stretch and recovery characteristic to woven fabric which contain yard strands further includes restricting the area of affixing the adhesive liquid with a print guide. The print guide may be attached to the trough. The print guide preferably has an opening sized equal to the area to be coated and to fit at least one of the dispenser and the spreader. In one embodiment, a position of the print guide relative to the fabric may be adjusted.

Imparting a desired stretch and recovery characteristic to woven fabric which contain yard strands further includes collecting excess adhesive liquid from the fabric. In one embodiment, excess adhesive liquid may be collected with a dam wall. The dam wall may be attached to the trough. A position of the dam wall relative to the fabric may be adjusted. A spring may be used to adjust the position of the dam wall relative to the fabric. In another embodiment, the print guide include a side wall perpendicular to the walls of the trough to collect excess adhesive liquid. The collection of excess adhesive liquid includes withdrawing the excess adhesive liquid collected by the dam wall or print guide side wall with at least one tube. The at least one tube preferably leads into a feed tank.

The desired stretch and recovery characteristic to woven fabric can include curing the adhesive liquid that is affixed to the fabric in an oven. The oven is often operated at a temperature greater than 300 degrees Fahrenheit.

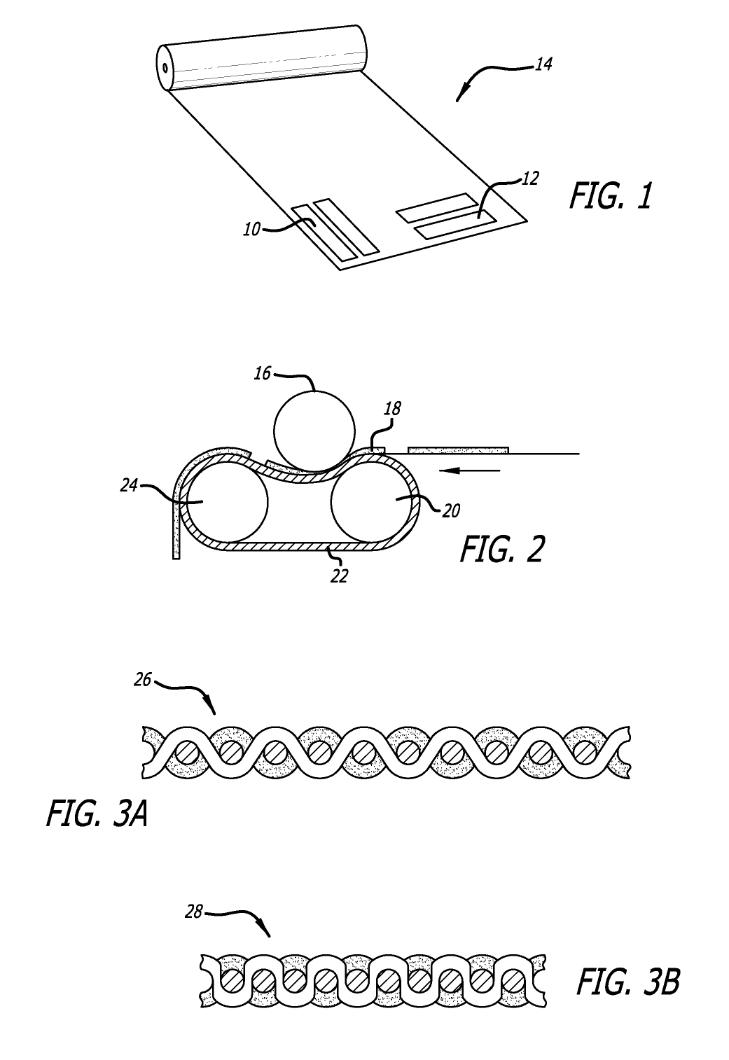

The fabric treated may be in full width form, but typically, as shown in FIG. 1, the fabric 14 is cut into strips 10, 12 either down the length of the piece 10 (i.e. in the warp direction—where continuous strips may be used) or at right angles across the piece 12 (i.e. in the weft direction). Different patterned fabric may influence the direction the fabric is cut. A higher degree of stretch may also be achieved by cutting the fabric at a predetermined angle to the warp or weft direction which creates additional ease dependent on the angle selected, also known as bias.

The fabric may be individual strips or it may be continuous reels. Continuous reels allow higher process efficiency and greater automation to be achieved. However, individual strips may be used based on a design standpoint.

Compaction of the fabric may be carried out by applying heat and pressure to the woven fabric, resulting in the yarn strands of the fabric to be forced closer together. This compaction of the yard strands imparts semi-permanent or permanent ease or stretch into the fabric. FIG. 3 shows a woven fabric where the strands before treatment 26 are drawn closer after treatment 28.

An apparatus may be used to apply a pressure necessary to compact the fabric. In one embodiment, as seen in FIG. 2, the compaction apparatus comprises a rubberized conveyor belt 22 driven by conveyor rollers 20, 24, and a heated roller 16 which is held against the belt 22 in close proximity to roller 20, so as to apply heat and pressure to a fabric strip 18 passing through the nip formed between rollers 16 and 20. The strips are placed onto the conveyor by the operator—the fabric strip direction being at right angles to the heated roller. The strip is progressed through the nip of the roller and rubberized conveyor.

The apparatus may also handle continuous reels of fabric. Continuous reels of fabric may be loaded onto the apparatus by an operator. For individual strips of fabric, the operator would have to locate and place the individual strips of fabric in access of the apparatus for compaction.

Preferably, the settings for the temperature and pressure of the steel roller, and the speed of the rubberized conveyor belt are pre-selected for one particular run or a series of runs. However, some or all of these settings may be varied depending on the degree of stretch required and the nature or composition of the material being processed.

The apparatus may also use steam, water mist, or other damping methods on the fabric to aid the compaction process. During the process, the yarn strands of the fabric are forced closer together. The extent of compaction is dependant upon multiple factors, including machine settings, moisture conditions, inherent thermal yarn shrinkage, and composition of the fabric. Upon exiting the apparatus, generally semi-permanent or ease or stretch will have been imparted to the fabric.

It is one aspect of the present disclosure that a fabric composite with desired stretch and recovery properties is achieved by affixing at least one adhesive liquid with known stretch and recovery characteristics onto a compacted stretchable fabric. The compacted stretchable fabric is manufactured by subjecting a non-stretch fabric, for example woven polyester/cotton, to the heat and pressure compaction process, whereby stretch is imparted to the fabric. A suitable adhesive liquid, such as an ink or plastisol with a known stretch and recovery characteristic, for example Spand-E-Sol, is then affixed to the compacted fabric. Usually, the adhesive liquid establishes its stretch and recovery characteristic once it is baked. When affixed, the adhesive liquid maintains the stretch and recovery properties of the compacted fabric imparted by the compaction process. The adhesive liquid may be any color to correspond with the color of the fabric, though a clear adhesive liquid is preferred. More than one adhesive liquid with different stretch and recovery characteristics may be used together to achieve a desired stretch and recovery characteristic for the fabric composite.

The process of manufacturing stretchable fabric composites has the advantage of avoiding extra sewing costs involved in conventional lining composite production and enables a wider range of fabrics to be utilized in the lining of trousers or skirts. Typically, the fabric would be in the form of a continuous reel for further sizing and shaping depending on its intended use.

In another aspect of the present disclosure, the compacted fabric is held in its compacted state by an elongated stabilizer. The elongated stabilizer keeps the compacted fabric from being stretched out before a adhesive liquid with a known stretch and recovery characteristic is applied on it. Examples of forces that would stretch the fabric include, the pulling of a continuous reel of fabric during its treatment process and during the spreading of the adhesive liquid onto the fabric. In one embodiment, as shown in FIGS. 5, 6 the elongated stabilizer is a dissolvable cord 52 stitched down the length of the compacted fabric 50. The cord holds the compaction in place while the adhesive liquid is affixed on top of it. The cord then dissolves upon washing of the fabric in water. In other embodiments, as shown in FIG. 7, tape 54 is preferably on the bottom and used to hold the compaction in place. The tape may be dissolvable or the tape may be removed prior to the entering of the fabric in a baking over used to cure the adhesive liquid. Multiple elongated stabilizers may be used depending on the amount of holding needed for the compacted fabric.

The stabilizing process of the compacted may be automated at a speed correlating to the speed of the fabric leaving the compactor. A sewing machine may be used to stitch a dissolvable cord onto the fabric or a tape dispenser may be used to affix tape onto the fabric. The position of the stitch is important, thus a sewing guide may be used to ensure that the fabric is fed into the sewing machine such that the cord/thread is stitched exactly where it is needed.

In another aspect of the disclosure, the compacted fabric held with an elongated stabilizer is fed through a trough during its treatment process. Fabric leaving a compaction apparatus may be fed through a sewing guide into the sewing machine and then into the trough or the fabric may be directly fed through the trough. The trough may be slightly wider than the width of the fabric, though the trough may be any size depending on the size and shape of the fabric. A trough wider than the width of the fabric may also include side blocks 80 as shown in FIG. 13, or other protrusions on its walls to eliminate undesired sideways movement of the fabric as it passes through the trough. In one example, the trough is straight and 4 feet in length, though trough length may be varied depending on the determined amount of space to be used for the trough or the shape of fabric to be processed. Longer and straighter troughs allow fabric to move in a straighter fashion during mass production. In one embodiment, as shown in FIGS. 5, 6 the trough 30 contains a groove 42 on its bottom inner surface. The groove allows a stitched dissolvable cord 52 to protrude into the trough, resulting in the compacted fabric 50 being able to lay flat as it is fed through the trough. Multiple grooves may be used if the compacted fabric is stitched with multiple dissolvable cords. The grooves are not essential and in another embodiment, shown in FIG. 7, grooves are not present when an elongated stabilizer such as tape 54 is used, which is usually on the bottom of the fabric.

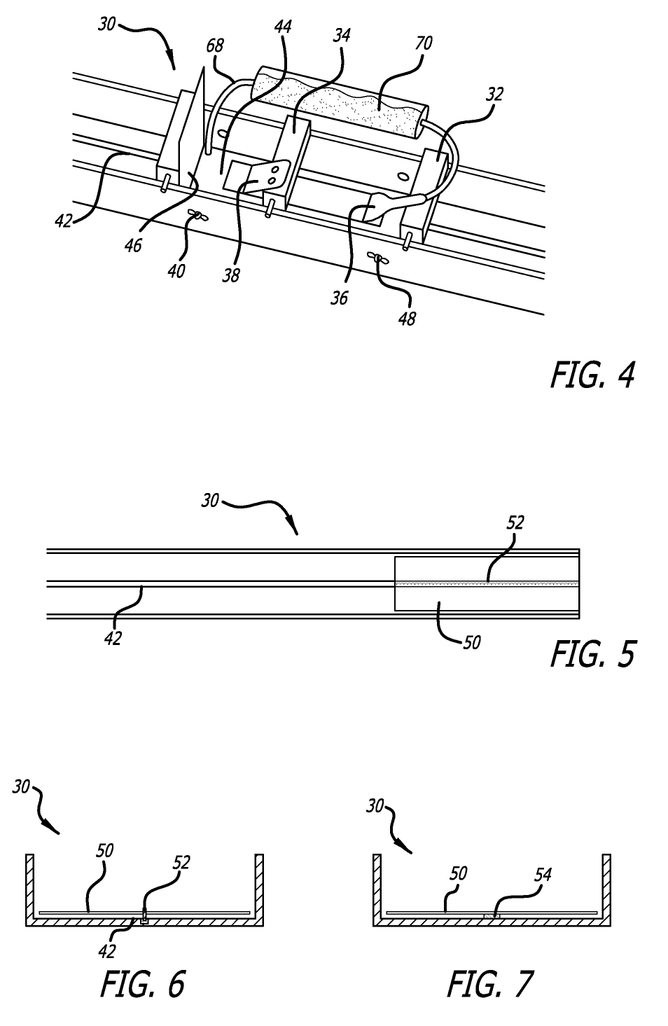

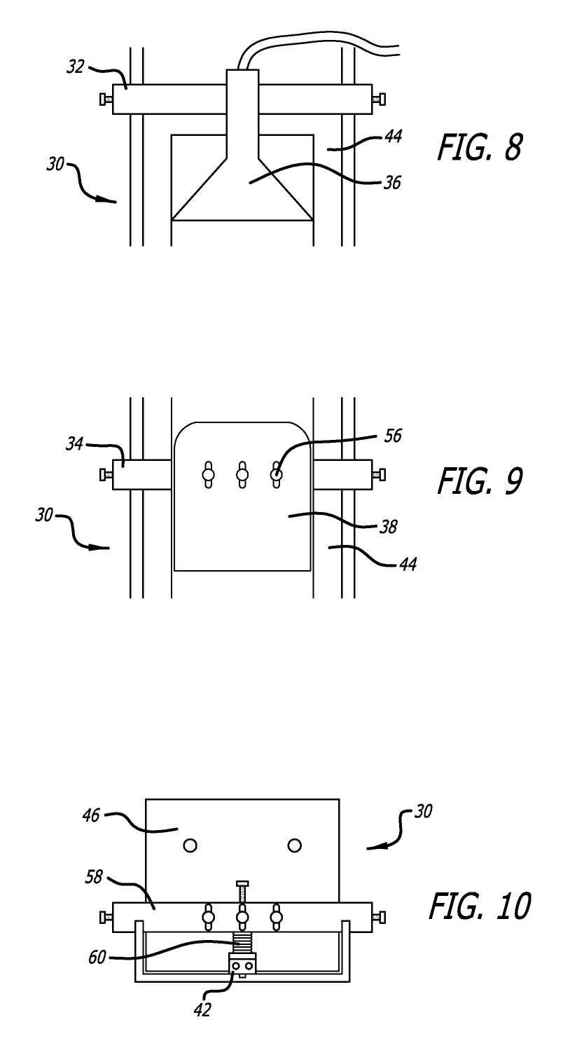

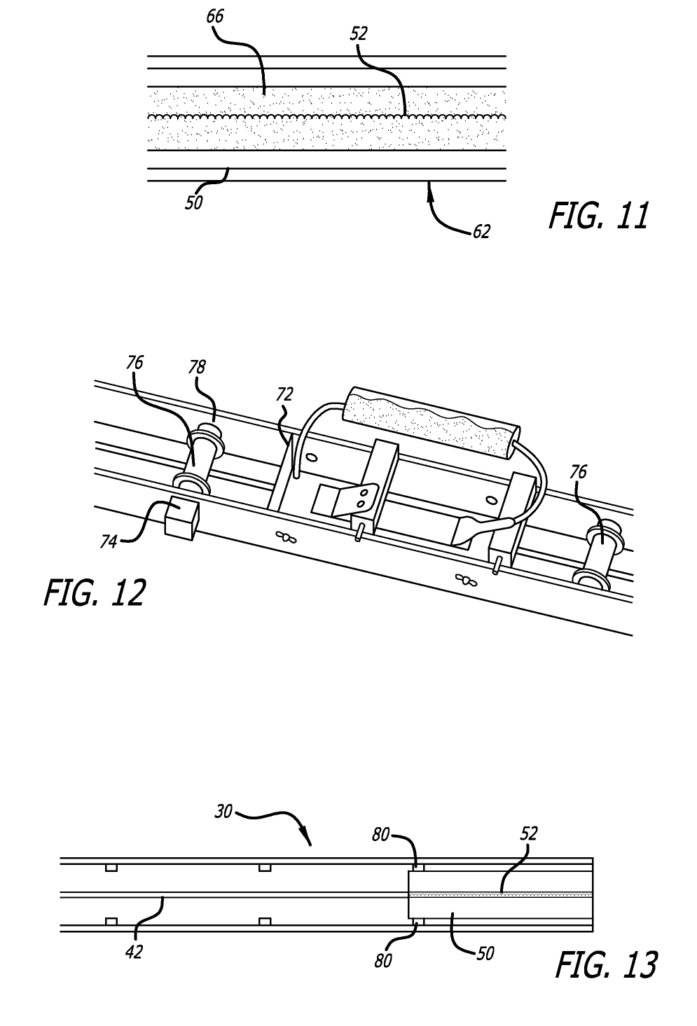

In a further aspect of the disclosure, a dispenser is attached to the trough. The dispenser, usually connected to a feed tank, releases the adhesive liquid onto the compacted fabric. An air pressure piston in the feed tank may be used to create pressure for dispensing the adhesive liquid. The height of the dispenser and the angle of the dispenser to the fabric may be adjusted, for example, by the adjustment bar 32 in FIG. 4, depending on the amount of adhesive liquid to be released. The dispenser may be different sizes and shapes, depending on the amount and location of the adhesive liquid to be applied. In one embodiment, as shown in FIG. 8, the dispenser is a broadened opening 36. In another example, the dispenser is comb-shaped, allowing the adhesive liquid to be released on the fabric in multiple lines. In another embodiment, the dispenser is a spray that sprays the adhesive liquid onto the compacted fabric.

In another aspect of the disclosure, a spreader is attached to the trough. As shown in FIG. 9, the spreader 38 allows the adhesive liquid to be evenly applied to a strategically determined surface area. The height and angle of the spreader relative to the fabric may be adjusted, for example, by the adjustment bar 34 and screws 56, depending on the amount of adhesive liquid to be affixed on the fabric. Positioning the spreader at an increased height allows for a thicker layer of adhesive liquid to be affixed on the fabric. Positioning the spreader at a decreased height allows for a thinner layer of adhesive liquid to be affixed to the fabric.

In a further aspect of the disclosure, a print guide is attached to the trough. The guide allows the adhesive liquid to be released and spread in a strategically determined surface area. The print guide has an opening with a width that allows the dispenser and spreader to be placed within the opening. In one embodiment, as shown in FIGS. 4, 8, 9, the width of the dispenser and the spreader are approximately the width of the opening in the print guide. The height of the guide relative to the fabric may be adjusted, depending of the amount of adhesive liquid to be affixed on the fabric. As shown in FIG. 4, nuts 40, 48 and nuts on the opposite side of the trough are used to adjust the height of the guide.

In another aspect of the disclosure, as shown in FIG. 12, the guide includes a side wall 72 at the end of the guide that is perpendicular to the walls of the trough. The print guide side wall 72 screens out excess adhesive liquid on the fabric. In one embodiment, a tube on the side of the print guide side wall withdraws excess adhesive liquid back into a feed tank connected to the dispenser, allowing recycling of excess adhesive liquid.

In another aspect of the disclosure, as shown in FIG. 10, a dam wall is attached to the trough 30. The dam wall is used instead of a print guide side wall to screen out excess adhesive liquid on the fabric. In one embodiment, as shown in FIG. 4, a tube 68 on the side of the dam wall withdraws excess adhesive liquid back into a feed tank 70 connected to the dispenser 36, allowing recycling of excess adhesive liquid. A spring screw 60 is located on the back of the dam wall to control the height the wall is raised, depending on the thickness of the fabric, elongated stabilizer, and stretchable adhesive liquid desired.

In another aspect of the disclosure, as shown in FIG. 12, at least one roller 76 is attached to the trough to pull the fabric through the trough. In one embodiment, the roller is attached near the end of the trough, though more than one roller may be attached at multiple locations on the trough depending on the pulling force desired. The desired pulling force may be determined by factors such as the weight of the fabric, weight of the applied adhesive liquid, and length of the trough. The height of the guide relative to the fabric may also be adjusted. A motor 74 may be attached to the side of the roller to directly rotate the roller. A motor may also be located elsewhere to rotate the roller indirectly through methods such as gears and belts. This allows for a single motor that simultaneously rotates multiple rollers attached to the trough.

In one embodiment of the disclosure, the roller includes rings 78 on the sides of the roller for pulling the fabric. The rings 78 allow the roller to contact the fabric only on the edges of the fabric where the rings contact the fabric and not in the middle where adhesive liquid has been applied. The number of rings on the sides of the roller, width and height of the rings may be changed as desired depending on the fabric and amount of adhesive liquid affixed.

The compacted fabric affixed with a desired amount of stretchable adhesive liquid is placed in an oven to be cured, usually at a temperature greater than 300 degree Fahrenheit. The fabric may be washed to remove a dissolvable elongated stabilizer and may also be folded in preparation for attachment to a garment. The stretchable fabric composite may be further processed, for example, be fed through an overlock machine to eventually provide for a curtain finish or be sewn to a pre-formed stretch/bias lining or lining composite.

Preferably, the settings for the angles of the various components and the speed of the movement of the fabric are pre-selected for one particular run or series of runs, but some or all of these settings can be varied depending on the amount of adhesive liquid to be affixed and the nature or composition of the material being processed.

The fabric or fabric composite produced in accordance with the present disclosure having stretch potential is primarily intended to be incorporated in a waistband around the waists of garments such as trousers or skirts, though the product could also be utilized for any other part of a garment where its benefits would be advantageous. For example, the fabric may provide ease around cuffs, pocket mouths, trouser bottoms, sleeve heads etc. It could also have wider applications to textile articles other than garments, where stiffening or reinforcing with a certain degree of stretch is required.

While the apparatus and method have been described in terms of what are presently considered to be the most practical and preferred embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures.

Many other applications are also envisaged, for example tapes produced for seam sealing in the manufacture of waterproof outer-garments. Conventionally, tapes for this purpose have to be cut on the bias in order to have sufficient stretch, whereas using a tape made from fabric treated according to the present invention has stretch or ease built in and therefore removes the need for biasing.

A conveyor belt, or multiple conveyor belts that allow a stitched dissolvable cord to protrude between them, may be used as the bottom surface of the trough, to help move the compacted fabric along the trough. Cogs before or after the oven may also be used to pull the fabric through the trough. A pre-determined pace for movement of the fabric may be used that corresponds to the speed of the fabric leaving the compaction apparatus and/or the time needed for the fabric to be adequately cured in the oven.

Other methods of affixing the adhesive liquid to the fabric are also possible. The compacted fabric may be dipped into the adhesive liquid. Rollers may be used where some rollers release adhesive liquid and spread the adhesive liquid onto the fabric and while other rollers are heated and used to bake the adhesive liquid.

Combinations of multiple elongated stabilizers, troughs, dispensers, spreaders, print guides, and dam walls may be used together on the same fabric or on multiple fabrics running simultaneously.

The present disclosure includes any and all embodiments of the following claims.

1. A method of imparting a desired stretch and recovery characteristic to woven fabric that contain yard strands, the method comprising:
providing a fabric having yarn strands that are in a compacted state; and
affixing at least one adhesive liquid with known stretch and recovery characteristics to the fabric with the yarn strands in a compacted state, thereby maintaining the desired stretch and recovery characteristic of the fabric.

2. The method of claim 1 wherein the adhesive liquid establishes a stretch and recovery characteristic once the adhesive liquid is baked or cured.

3. A method of imparting a desired stretch and recovery characteristic to woven fabric that contain yard strands, the method comprising:
applying heat and pressure to the fabric in such a manner that the yarn strands are forced into a compacted state;
affixing stretchable and recoverable adhesive ink or plastisol to the fabric with the yarn strands in a compacted state, thereby maintaining the desired stretch and recovery characteristic of the fabric.

4. The method of claim 1 further including affixing at least one elongated stabilizer to the fabric with the yarn strands in a compacted state, thereby stabilizing the yard strands in the compacted state prior to affixing the at least one adhesive liquid with known stretch and recovery characteristics to the fabric.

5. The method of claim 4 wherein the elongated stabilizer is dissolvable.

6. The method of claim 4 wherein the elongated stabilizer is a cord, thread, or tape.

7. The method of claim 1 further including guiding the fabric through a trough having an inner bottom surface.

8. The method of claim 5 wherein the inner bottom surface is at least one conveyor belt.

9. The method of claim 5 wherein the trough has a groove on the inner bottom surface.

10. The method of claim 9 wherein the groove is sized such that a stitched cord may protrude into the groove thereby allowing the fabric to lay flat on the inner bottom surface.

11. The method of claim 1 further including dispensing the adhesive liquid with a dispenser.

12. The method of claim 11 wherein the dispenser is attached to the trough.

13. The method of claim 11 wherein the dispenser has a broadened opening.

14. The method of claim 11 wherein the dispenser is a spray.

15. The method of claim 11 wherein the dispenser is attached to a feeding tank.

16. The method of claim 11 wherein at least one of an angle and a position of the dispenser relative to the fabric may be adjusted.

17. The method of claim 1 further including spreading the adhesive liquid with a spreader.

18. The method of claim 17 wherein the spreader is attached to the trough.

19. The method of claim 17 wherein at least one of an angle and a position of the spreader relative to the fabric may be adjusted.

20. The method of claim 1 further including restricting the area of affixing the adhesive liquid with a print guide.

21. The method of claim 20 wherein the print guide is attached to the trough.

22. The method of claim 20 wherein the print guide has an opening sized to fit at least one of the dispenser and the spreader.

23. The method of claim 20 wherein a position of the print guide relative to the fabric may be adjusted.

24. The method of claim 21 further including collecting excess adhesive liquid from the fabric with a side wall of the print guide.

25. The method of claim 1 further including collecting excess adhesive liquid from the fabric with a dam wall.

26. The method of claim 25 wherein the dam wall is attached to the trough.

27. The method of claim 25 wherein a position of the dam wall relative to the fabric may be adjusted.

28. The method of claim 27 wherein a screw spring is used to adjust the position of the dam wall relative to the fabric.

29. The method of claim 25 further including withdrawing the excess adhesive liquid collected by the dam wall with at least one tube.

30. The method of claim 29 wherein the at least one tube leads into a feed tank.

31. The method of claim 1 further including curing the adhesive liquid that is affixed to the fabric in an oven.

32. The method of claim 31 wherein the oven is operated at a temperature greater than 300 degrees Fahrenheit.

33. The method of claim 21 further including pulling the fabric through the trough with at least one roller, the roller having two opposite sides.

34. The method of claim 33 wherein the two opposite sides of the roller each has at least one ring for contacting the fabric.
